(19) United States
(12) Patent Application Publication
(10) Pub. No.: US 2010/0071555 A1
(43) Pub. Date: Mar. 25, 2010

(54) METHOD AND APPARATUS FOR FILTERING PROCESS GAS

(75) Inventors: Martti Jankkila, Kiviranta (FI); Pekka Niemelä, Kiviranta (FI); Pekka Rantala, Tornio (FI)

Correspondence Address: BUCHANAN, INGERSOLL & ROONEY PC, POST OFFICE BOX 1404, ALEXANDRIA, VA, 22313-1404, US

(73) Assignee: Outotec Oyj, Espoo (FI)

(21) Appl. No.: 12/519,540

(22) PCT Filed: Dec. 18, 2007
(86) PCT No.: PCT/FI2007/000295

§ 371 Date: Jun. 17, 2009

(30) Foreign Application Priority Data
Dec. 19, 2006 (FI) 20061133
Dec. 11, 2007 (FI) 20070961

(51) Int. Cl. B01D 29/68; B01D 41/00

(52) U.S. Cl. 95/280; 95/279; 96/233

(57) ABSTRACT

The invention relates to a method and an apparatus for filtering process gas created in the ferroalloy smelting process, i.e. carbon monoxide gas, in order to essentially reduce the content of solids in the gas. In the filtering unit (24) gas containing solids is conducted through at least one filtering element (7), inert gas blowing (8) is directed to the filtering element (7) in order to detach the solid material from the surface of the filtering element (7), and in order to remove from the filtering unit (24) the solid material detached from the the surface of the filtering element (7) the solid material is slurried by means of liquid fed (11) into the filtering unit (24). The slurry containing the sold material is removed from the filtering unit (24) through a discharge chamber (12). The filtering unit (24) includes a filtering chamber (1) and a discharge chamber (12) that is mechanically connected to the filtering chamber, as well as a discharge conduit (6) for the solids filtered from the gas, and the filtering chamber (1) is provided with at least one filtering element (7) for separating solids from the gas and at least one nozzle (8, 11) for discharging the filtered solids from the filtering chamber (1).

The present invention relates to a method and an apparatus for filtering process gas created in the ferroalloy smelting process, i.e. carbon monoxide gas, in order to essentially reduce the quantity of solids contained in the gas.

For cleaning exhaust gases created in metal smelting processes of solids, for instance for cleaning gases created in a ferroalloy smelting process, there is generally used a venturi scrubber. The solids bearing gas to be cleaned is conducted through the top part of the scrubber to a venturi scrubber, and a water jet is directed to the downwards proceeding gas flow. Owing to the water jet, solids contained in the gas are washed in the water, and the cleaned gas is conducted away from the venturi scrubber through a discharge aperture provided in the top part. In order to improve the solids separation capacity of a venturi scrubber, two or more venturi scrubbers can be installed in series, so that the gas to be cleaned is conducted through all scrubbers. However, even this method results in a purity level of only 50-200 mg/Nm³ which is not sufficient, in case the cleaned gas should be utilized without any problems in the various different process steps in ferroalloy production, or elsewhere in demanding targets.

Moreover, in the treatment of process gases, such as carbon monoxide gas created in a ferroalloy smelting process, it is also necessary to observe that carbon monoxide gas as such is dangerous. Therefore in the treatment of carbon monoxide gas, the requirements of safety at work and the surroundings must be carefully taken into account, so that essentially no amount of the carbon monoxide gas is allowed to escape to the surrounding working space.

The object of the present invention is to eliminate drawbacks of the prior art and to achieve an improved method and apparatus for cleaning solids from process gas, i.e. carbon monoxide gas created in a ferroalloy process, so that the process gas can be advantageously utilized for instance for heating in process steps preceding the smelting process and/or following the smelting process. The essential novel features of the invention are apparent from the appended claims.

The method and apparatus according to the invention for cleaning process gas, i.e. carbon monoxide gas created in the ferroalloy smelting process, is provided, preferably first with respect to the gas flow direction, with at least one gas scrubber known as such, where the separation of gas and solids is carried out preferably by a liquid medium. The cleaned process gas, i.e. carbon monoxide gas, is further conducted to at least one gas filtering unit, where the filtering is performed as dry separation. When desired, in between the gas scrubber and the gas filtering unit, there can be installed a gas blower, in which case the gas flowing rate between the scrubber and the filtering unit can be increased.

In an apparatus according to the invention, the gas filtering unit is formed of a filtering chamber with a cross-sectional surface that is preferably essentially round and essentially cylindrical in shape. A conical bottom part can be advantageously provided in the filtering chamber of the gas filtering unit. Thus the gas filtering unit also is made compact. In the flowing direction of the processed gas, at the first end of the cylindrical element or near the first end thereof, there is installed a conduit for feeding the gas to be processed to the filtering chamber, and at the other end of the cylindrical element or near the other end of the cylindrical element, there is installed a conduit for discharging gas from the filtering chamber. The filtering chamber is advantageously installed in an essentially vertical position, in which case in the lower part of the filtering chamber, or in a bottom part connected to the lower part thereof, there also is formed a discharge aperture for the solids separated from the gas. The cross-sectional surface of a filtering chamber according to the invention can also be essentially rectangular or for example oval-shaped.

According to the invention, inside the filtering chamber there are advantageously installed several filtering elements. It is also possible to install only one filtering element in the filtering chamber, in case the quantity of the processed gas is essentially small, but with respect to installing and maintaining elements, it is more advantageous to use several filtering elements in the chamber. The filtering elements are installed in the filtering chamber so that the filtering elements essentially cover the whole cross-sectional surface in the filtering chamber, or advantageously at least that part of the cross-sectional surface through which the gas to be processed in the filtering chamber is conducted from the filtering chamber inlet aperture to the outlet aperture. The filtering element is preferably made of a porous material, plastic or other such material, for example ceramic material, through which the gas to be cleaned can flow. Thus the solid material contained in the gas can be separated therefrom, because the passage of solids through the filtering element is prevented. The filtering element can also be made of metal.

In addition, the filtering chamber in a filtering unit according to the invention is provided with a conduit through which an inert gas used for cleaning the filtering elements, such as a nitrogen, is conducted, and with a conduit through which a liquid medium, such as water, used for removing the solids, separated from the filtering elements, from the filtering chamber, is conducted to the filtering chamber. At the ends connected to the filtering chamber, both conduits are provided with at least one nozzle, by which the material to be fed can be conducted in the desired direction. Thus the processing of solids takes place in the filtering chamber, partly as dry separation and partly as wet separation. The nozzle meant for feeding the inert gas is directed towards the filtering elements for removing the solids stuck on the surface of the filtering elements. The conduit for the gas used for cleaning the filtering elements is provided with a control unit, by which it is adjusted for instance the duration or strength of one blast of gas flowing through the conduit, as well as the frequency of the blast period.

The liquid medium, such as a water, used for discharging the solids stuck on the filtering elements from the filtering chamber is by means of the nozzles advantageously directed so that when using several nozzles, at least part of them are preferably pointed so that the liquid medium flowing through the nozzles is directed towards the solids detached from the filtering elements, from the filtering chamber walls, and part of the nozzles are pointed towards removing solids from the free space of the filtering chamber. The solids are removed by means of said medium either continuously or preferably in repeated periods. The slurry formed of the liquid medium and the solids separated from the gas are discharged from the filtering chamber through a slurry discharge aperture formed in the lower part of the chamber or in a bottom part connected to the filtering chamber.

The solids discharge aperture in the filtering chamber is connected to a discharge conduit, preferably a discharge pipe, which is provided, in the solids flowing direction, essentially near to the first end of the discharge conduit and thus to the end connected to the filtering chamber, by two blocking elements, one of them being installed in the immediate vicinity of the discharge aperture, and the other blocking element being installed at a distance from the first blocking element. The space left between the blocking elements in the discharge conduit constitutes the solids discharge chamber. The discharge chamber can also be a separate part with respect to the discharge conduit, provided with blocking elements, in which case the discharge conduit is connected to the discharge chamber. Now the discharge chamber is on one hand connected to the solids discharge aperture of the filtering chamber, and on the other hand to the discharge conduit, so that both the discharge aperture of the filtering chamber and the junction of the discharge conduit are provided with blocking elements. The blocking elements are made to function reciprocally, so that at least one of the blocking elements is always closed, when carbon monoxide gas to be cleaned flows through the filtering chamber. By means of the closed blocking element, the carbon monoxide gas is prevented from flowing from the discharge chamber to the discharge conduit or to the part provided in the discharge conduit in succession to the discharge chamber, and therethrough to the surrounding space. The discharge conduit is advantageously designed so that in the discharge conduit, there can be created a liquid seal, such as a water seal. The discharge conduit can also be connected to an element in which there can be created a liquid seal, such as a water seal. By means of liquid seal it is preferably prevented the access of carbon monoxide in the gaseous state to the free surrounding space.

The feeding of the liquid medium, as well as the operation of the blocking elements constituting the discharge chamber, are in the method according to the invention advantageously adjusted by the same control unit that also conducts the feeding of the inert gas into the filtering chamber. However, the feeding of inert gas and liquid medium as well as the operation of the discharge chamber blocking elements can also be adjusted through a separate control unit.

When an apparatus according to the invention is in operation and using the method of the invention, the gas obtained from a metal smelting process and containing solids-bearing exhaust gas, i.e. carbon monoxide gas, is first conducted to be cleaned in a venturi scrubber known as such, where a water jet is directed to the downwards proceeding gas flow. Owing to the water jet, part of the solids contained in the carbon monoxide gas are removed along the water flow to the lower part of the scrubber, whereas the gas is made to flow upwards, towards the gas discharge aperture. Depending on the gas pressure of the carbon monoxide gas flowing out of the scrubber, the carbon monoxide gas is conducted either directly to the filtering unit or first to a gas blower, in which the carbon monoxide gas pressure can be increased by blasting before entering the filtering unit. The use of a blower is significant at least when the pressure of the gas emitted from the scrubber is insufficient with respect to the pressure loss taking place in the filtering unit.

Through the inlet aperture of the filtering chamber of the filtering unit, the carbon monoxide gas to be filtered flows towards the filtering elements provided in the filtering chamber, in which case the solid material contained in the gas is stopped on the surface of the filtering element, and the cleaned gas in itself flows further through the filtering elements. For cleaning the filtering elements, they are subjected to nitrogen gas blasting, the duration, pressure and periodic frequency is adjusted by a control unit. Through nozzles installed in the filtering unit, water is fed in the filtering unit for conducting the solid material detached from the filtering elements to the lower part of the filtering unit. Essentially simultaneously with the starting of the water feed, there is opened, in the flowing direction of the discharge aperture provided in the lower part of the filtering chamber, the first blocking element for discharging the slurry, formed of water and the solids removed from the filtering elements, from the filtering chamber to the solids discharge chamber. When the feeding of water is stopped, the first blocking element in the flowing direction of the discharge aperture used for removing slurry is closed

For conducting the slurry contained in the discharge chamber away from the discharge chamber, the second blocking element provided in the flowing direction of the discharge aperture used for removing slurry is opened, and the slurry is allowed to flow to the part of the discharge conduit that is located after the discharge chamber. The discharge conduit is advantageously designed so that the slurry flows through a water seal created in the discharge conduit and therethrough to further processing. Thus the carbon monoxide gas possibly carried along with the slurry can be removed before the slurry proceeds to the surrounding free space after the discharge conduit.

Because the process gas filtered according the method and apparatus of the invention is carbon monoxide gas, that already in small contents is very dangerous to life, it is important, that during filtering of carbon monoxide gas the access of the gas is prevented to the surrounding free space.

When using the apparatus according to the invention, the solid content in the carbon monoxide gas after filtering is less than 5 mg/Nm³, preferably less than 1 mg/Nm³.

The invention is explained in more detail below, with reference to the appended drawings, where

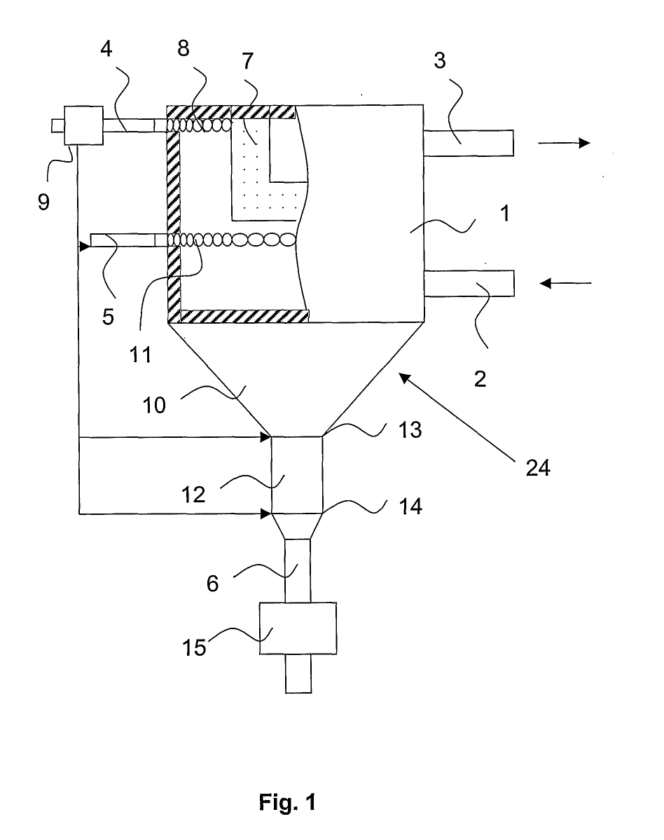

FIG. 1 illustrates a filtering unit according to the invention in a partly cross-sectional side-view illustration, and

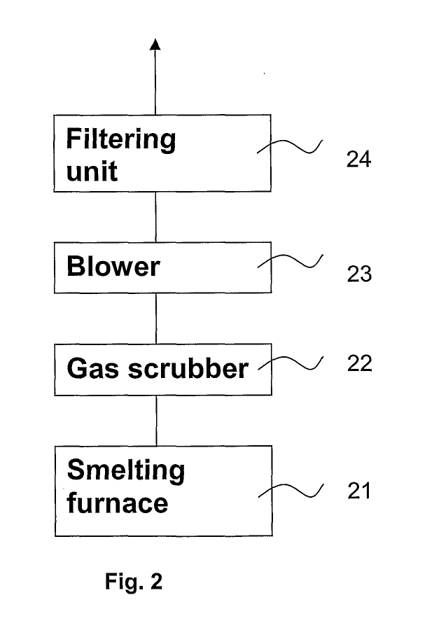

FIG. 2 illustrates a flowsheet connected to the filtering unit according to the invention.

According to FIGS. 1 and 2, to the filtering chamber 1 of the filtering unit, there are connected conduits for the input 2 and outlet 3 of the carbon monoxide gas to be treated in the filtering unit. Likewise, to the filtering chamber 1, there are connected conduits for feeding inert gas 4, for feeding water 5 and for removing 6 the solids separated from the gas.

The carbon monoxide gas flowing to the filtering chamber 1 is conducted through the inlet aperture of the conduit 2 to a filtering element 7 that is made of finely ground polyethylene by heat treatment, and through which the carbon monoxide gas has access to flow. After flowing through the filtering element 7, the carbon monoxide gas is conducted through the outlet aperture of the conduit 3 to be utilized further. The solids that were contained in the carbon monoxide gas remain on the surface of the filtering element 7, to which there is directed nitrogen gas periodically in continuous operation through gas nozzles 8 connected to the conduit 4. The nitrogen gas blast is controlled by a control unit 9 connected to the conduit 4. The solids removed by the nitrogen gas are lowered down towards the bottom part 10 of the filtering chamber 1, and in order to facilitate the removal of solids, water is conducted to the filtering chamber 1 through a conduit 5 and directed, by nozzles 11 connected to the conduit 5, at least partly onto the filtering chamber walls. Thus the slurry formed of solids and water flows towards the bottom of the bottom part 10, which is provided with a blocking element 13. The blocking element 13 is used for adjusting the flowing of the slurry to a discharge chamber 12 provided underneath the bottom part 10. By means of the discharge chamber 12, the carbon monoxide gas possibly carried along with the slurry is prevented from flowing out of the filtering unit 1 to the surroundings, so that the discharge chamber 12 is provided with a blocking element 14 also at the other end with respect to the slurry flowing direction. The operation of the blocking elements 13 and 14 is adjusted by means of the control unit 9, so that only one of the blocking elements 13 or 14 is in turn in the open position, while the other is in the closed position. The slurry discharged from the discharge chamber 12 is conducted to a discharge conduit 6 provided with a water seal 15 to ensure that the carbon monoxide has no access to flow to the surroundings, in case the mutual operation of the blocking elements 13 and 14 should be disturbed, for example. The control unit 9 is also used for controlling the use of the water nozzles 11.

According to the flowsheet of the carbon monoxide gas illustrated in FIG. 2, the carbon monoxide gas obtained from the smelting furnace 21 is first conducted to a gas scrubber 22, where part of the solids contained in the gas is removed when necessary. In order to ensure a sufficient pressure for the carbon monoxide gas, the gas is conducted to the filtering chamber 1 of the filtering unit 24 through a blower 23.

1. Method for filtering process gas created in the ferroalloy smelting process, i.e. carbon monoxide gas, in order to essentially reduce the content of solids in the gas, in which method carbon monoxide gas is conducted to at least one gas filtering unit (24), characterized in that wherein in the filtering unit (24) gas containing solids is conducted through at least one filtering element (7), inert gas blowing (8) is directed to the filtering element (7) in order to detach the solid material from the surface of the filtering element (7), and that in order to facilitate the removal of the solid material detached from the the surface of the filtering element (7) the solid material is slurried by means of liquid fed (11) into the filtering unit (24) and that the slurry containing the sold material is removed from the filtering unit (24) through a discharge chamber (12).

2. Method according to the claim 1, wherein carbon monoxide gas is conducted to the filtering unit (24) through a gas scrubber (22).

3. Method according to the claim 1, wherein carbon monoxide gas is conducted to the filtering unit (24) periodically in continuous operation.

4. Method according to claim 1, wherein inert gas is conducted into filtering unit (24) periodically in continuous operation.

5. Method according to claim 1, wherein slurry containing solid material is conducted away from the filtering unit (24) through a liquid seal.

6. Method according to claim 1, wherein solid content in the carbon monoxide gas after filtering (24) is less than 5 mg/Nm³, preferably less than 1 mg/Nm³.

7. An apparatus for filtering process gas created in the ferroalloy smelting process, i.e. carbon monoxide gas, in order to essentially reduce the content of solids in the gas, wherein the filtering unit (24) includes a filtering chamber (1) and a discharge chamber (12) that is mechanically connected to the filtering chamber, as well as a discharge conduit (6) for the solids filtered from the gas, and that the filtering chamber (1) is provided with at least one filtering element (7) for separating solids from the gas and at least one nozzle (8,11) for discharging the filtered solids from the filtering chamber (1) and that the filtering unit (24) is provided at least one nozzle in the conduit (4) for inert gas and at least one nozzle in the conduit (5) for liquid medium.

8. An apparatus according to claim 7, wherein a gas scrubber (22) is installed prior to the filtering unit (24) in the gas flowing direction.

9. An apparatus according to claim 7, wherein at least the inlet aperture in the solids discharge chamber (6) is provided with a blocking element (13).

10. An apparatus according to claim 7, wherein the solids discharge chamber (12) forms part of the discharge conduit (6) connected to the filtering chamber (1).

11. An apparatus according to claim 10, wherein at that end of the discharge conduit (6) that is connected to the filtering chamber, there is installed a first blocking element (13), and a second blocking element (14) at a distance from the first blocking element (13), and that the space left in between the blocking elements in the discharge conduit (6) constitutes a solids discharge chamber.

12. An apparatus according to claim 7, wherein the solids discharge chamber (12) is installed as a separate element in between the filtering chamber (1) and the discharge conduit (6).

13. An apparatus according to claim 12, wherein the solids discharge chamber (12) is provided with a blocking element (13,14) at the junctions of both the filtering chamber (1) and the discharge chamber (12), and of the discharge chamber (12) and the discharge conduit (6).

14. An apparatus according to claim 7, wherein the discharge conduit (6) is provided with a liquid seal (15).

15. An apparatus according to claim 7, wherein the discharge conduit (6) is connected to an element that is provided with a liquid seal (15).

16. An apparatus according to claim 7, wherein the filtering chamber (1) is provided with at least one nozzle (8) for feeding inert gas to the filtering chamber (1).

17. An apparatus according to claim 7, wherein the filtering chamber (1) is provided with at least one nozzle (11) for feeding liquid medium to the filtering chamber (1).
